(19) United States
(12) Patent Application Publication
(10) Pub. No.: US 2008/0028556 A1
(43) Pub. Date: Feb. 7, 2008

(54) PAINT BRUSH CLEANING DEVICE

(76) Inventor: Hans Papenfuss, Naples, FL (US)

Correspondence Address: FRASER CLEMENS MARTIN & MILLER LLC, 28366 KENSINGTON LANE, PERRYSBURG, OH, 43551, US

(21) Appl. No.: 11/766,947

(22) Filed: Jun. 22, 2007

Related U.S. Application Data
(60) Provisional application No. 60/815,776, filed on Jun. 22, 2006.

(51) Int. Cl. A46B 17/06; B05B 1/20; B08B 3/02

(52) U.S. Cl. 15/142; 134/199; 239/565

(57) ABSTRACT

A device for cleaning a paint brush includes a manifold having a plurality of substantially equally spaced nozzles extending therefrom. A manifold housing is connected to a supply of pressurized water by a hose. Alternatively, the housing is connected to a ball valve assembly, which is in turn connected to the supply of pressurized water. Preferably, the ball valve assembly includes a two-piece valve body.

### CROSS-REFERENCE TO RELATED APPLICATION

This application claims the benefit of U.S. provisional patent application Ser. No. 60/815,776 filed Jun. 22, 2006.

### BACKGROUND OF THE INVENTION

The present invention relates generally to an apparatus for cleaning and, in particular, to an apparatus for cleaning paint brushes.

The following patents provide background in the field of cleaning devices:

The U.S. Pat. No. 734,887 entitled “Broom Attachment”.

The U.S. Pat. No. 1,233,147 entitled “Nozzle”.

The U.S. Pat. No. 2,709,112 entitled “Lawn Sprinkling Nozzles”.

The U.S. Pat. No. 3,754,557 entitled “Liquids and Fluids Dispensing Applicator Assembly”.

The U.S. Pat. No. 4,022,382 entitled “Surface Cleaning Device”.

The U.S. Pat. No. 4,095,746 entitled “Self-Supported Water Sweeper”.

The U.S. Pat. No. 4,823,424 entitled “Paint Brush Cleaning Funnel”.

The U.S. Pat. No. 4,865,188 entitled “Paint Brush Cleaning Assembly”.

The U.S. Pat. No. 4,930,706 entitled “Water Broom”.

The U.S. Pat. No. 5,381,964 entitled “Water Jet Spray Nozzle for Cleaning a Paintbrush”.

The U.S. Pat. No. 5,406,967 entitled “Paint Brush Cleaning Device”.

The U.S. Pat. No. 6,089,865 entitled “Tongue Cleaning Device”.

The U.S. Pat. No. 6,244,273 entitled “Water Comb”.

The U.S. Pat. No. 6,779,535 entitled “Paint Brush Cleaning Device”.

The U.S. Pat. No. D425,678 entitled “Paintbrush Cleaning Wand”.

### SUMMARY OF THE INVENTION

The present invention concerns a paint brush cleaning device that includes a manifold having a plurality of substantially equally spaced nozzles extending therefrom. The housing is connected to a supply of pressurized water by a hose. Alternatively, the housing is connected to a ball valve assembly, which is in turn connected to the supply of pressurized water. Preferably, the ball valve assembly includes a two-piece valve body. Advantageously, the device may be utilized to clean objects other than paint brushes.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is an exploded perspective view of a cleaning device in accordance with the present invention; and

FIG. 2 is an exploded perspective view of an alternative embodiment of a cleaning device in accordance with the present invention.

### DESCRIPTION OF THE PREFERRED EMBODIMENT

U.S. provisional patent application Ser. No. 60/815,776 filed Jun. 22, 2006 is hereby incorporated herein by reference.

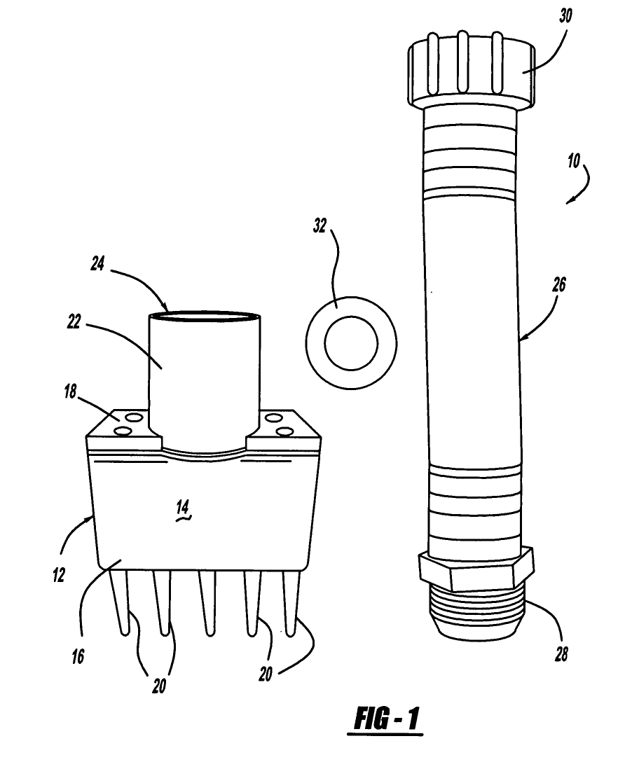

Referring now to FIG. 1, a paint brush cleaning device in accordance with the present invention is indicated generally at 10. The device 10 includes a hollow housing or manifold 12 that defines an interior cavity 14 between a first end 16 and a second end 18 thereof. Preferably, the manifold 12 is manufactured from a plastic material including, but not limited to, Delrin® acetal resin available from the E. I. du Pont de Nemours and Company or another material having similar material properties. A plurality of elongated nozzles 20 extend from the first end 16 of the manifold 12 and are in fluid communication with the cavity 14. The nozzles 20 are preferably equally spaced along the first end 16 of the manifold 12. A supply conduit 22 extends from the second end 18 of the manifold 12 opposite the nozzles 16. The supply conduit 22 is in fluid communication with the interior cavity 14 and has an open end 24 that is adapted to be connected to a hose 26. The hose 26 includes a first end 28 adapted to be connected to the open end 24 of the manifold and a second end 30 that is adapted to be connected to a source of pressurized water, such as a hose bib (not shown), a sink faucet, (not shown) or the like. A gasket 32 is provided to assist in create a seal between the ends 24 and 28 and/or between the end 30 and the source of pressurized water. The connections between the device 10 and the hose 26 and between the hose 26 and the water source are preferably threaded type connections or similar releasable connections while remaining within the scope of the present invention, as will be appreciated by those skilled in the art.

In operation, the end 28 of the hose 26 is connected to the end 24 of the manifold 12 and the end 30 of the hose 26 is connected to the pressurized water source. When pressurized water from the water source is introduced to the end 30 of the hose 26, the water travels through the hose 26, into the conduit 22 and into the cavity 14. The high pressure water then is forced into the nozzles 20, whereby the velocity of the water increases and it exits the open ends of the respective nozzles 20. A user of the device 10 then preferably directs the high velocity water exiting from the nozzles 20 at the object to be cleaned, such as a paint brush (not shown) or the like. The spacing of the nozzles 20 is preferably optimized for a typical sized paint brush in order to efficiently remove paint from the bristles of the paint brush. Advantageously, the device 10 may be utilized to clean objects other than paint brushes, as will be appreciated by those skilled in the art.

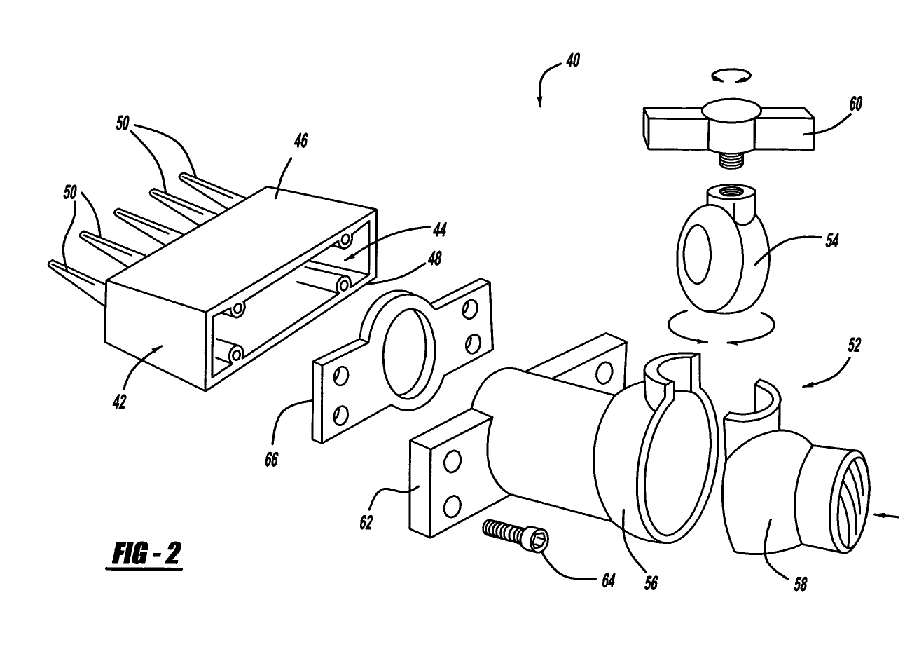

Referring now to FIG. 2, an alternative embodiment of a paint brush cleaning device in accordance with the present invention is indicated generally at 40. The device 40 includes a hollow housing or manifold 42 that defines an interior cavity 44 between a first end 46 and a second end 48 thereof. A plurality of elongated nozzles 50 extend from the first end 46 of the manifold 42 and are in fluid communication with the cavity 44. The nozzles 50 are preferably equally spaced along the first end 46 of the manifold 42. A valve assembly 52 is adapted to be attached to the second end 48 of the manifold 42. The valve assembly 52 has a valve seat 54 that is adapted to be disposed between a first body half 56 and a second body half 58. A handwheel 60 is connected to the valve seat 54. Preferably, the body halves 56 and 58 are ultrasonically welded together or are attached by a similar robust attachment method, as will be appreciated by those skilled in the art. The first body half 56 is in fluid communication with the interior cavity 44 and includes a flange 62 extending outwardly therefrom that is sized to cooperate with the second end 48 of the manifold 42. The flange 62 is adapted to be attached to the second end 48 by a plurality of fasteners 64, such as screws or the like. A gasket 66 is provided to assist in create a seal between the flange 62 and the second end 48. The second body half 58 is adapted to be connected to a source of pressurized water, such as the hose 26 shown in FIG. 1, a hose bib (not shown), a sink faucet, (not shown) or the like. The connections between the device 40 and the water source are preferably threaded type connections or similar releasable connections while remaining within the scope of the present invention, as will be appreciated by those skilled in the art.

In operation, the flange 62 of the first body half 56 of the valve assembly 52 is connected to the end 44 of the manifold 12 with the gasket 66 placed therebetween and the second body half 58 of the valve assembly 52 is connected to the pressurized water source. When the user of the device 40 turns the handwheel 60, high pressure water flows from the water source and travels through the valve assembly 52, into the manifold 42 and into the cavity 44. The high pressure water then is forced into the nozzles 50, whereby the velocity of the water increases and it exits the open ends of the respective nozzles 50. A user of the device 40 then preferably directs the high velocity water exiting from the nozzles 50 at the object to be cleaned, such as a paint brush (not shown) or the like. The spacing of the nozzles 50 is preferably optimized for a typical sized paint brush in order to efficiently remove paint from the bristles of the paint brush. Advantageously, the device 40 may be utilized to clean objects other than paint brushes, as will be appreciated by those skilled in the art.

When utilized to clean a paint brush, the device 10 or 40 in accordance with the present invention often allows a user to clean a paint brush in a minute or less. This advantageously increases the life, usefulness, and utility of a single brush, as the device 10 or 40 may be utilized to clean a brush of a previously used color paint, which will allow the brush to be used again for a different color, increasing the efficiency of the painting process.

The paint brush cleaning device 10 or 40 in accordance with the present invention may be advantageously used inside or outside, provides thoroughly cleaned brushes in as little as one minute, permits one paint brush to be used for different colors with no residual bleeding and eliminates the damaging effects caused by soaking paint brushes.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A device for cleaning an article comprising:
a manifold including a first end and a second end, said second end being adapted to be connected to a supply of pressurized water; and
a plurality of nozzles extending outwardly from said first end of said manifold body, whereby when said second end of said manifold body is connected to said supply of pressurized water, water flows through said manifold body and out said nozzles.

2. The device according to claim 1 wherein said manifold is constructed of an acetal resin.

3. The device according to claim 1 including a valve assembly attached to said second end of said manifold body for selectively allowing water to flow from said supply of pressurized water to said manifold body.

4. The device according to claim 3 wherein said valve assembly includes a two-piece valve body.

5. The device according to claim 4 wherein valve body includes a flange extending therefrom for cooperation with said second end of said manifold body.

6. The device according to claim 4 wherein said valve body includes a ball valve disposed therein.

7. The device according to claim 1 where said nozzles are equally spaced along said first end of said manifold body.

8. The device according to claim 1 including a hose attached between said second end of said manifold and said supply of pressurized water.

9. The device according to claim 8 including a gasket disposes between said hose and said second end of said manifold.
